(19) United States
(12) Patent Application Publication
(10) Pub. No.: US 2025/0062389 A1
(43) Pub. Date: Feb. 20, 2025

(54) RECHARGEABLE BATTERY

(71) Applicant: SAMSUNG SDI CO., LTD., Yongin-si (KR)

(72) Inventor: Kyugil CHOI, Yongin-si (KR)

(21) Appl. No.: 18/732,904

(22) Filed: Jun. 4, 2024

(30) Foreign Application Priority Data
Aug. 17, 2023 (KR) 10-2023-0107787

(51) Int. Cl. H01M 10/04; H01M 50/105; H01M 50/533

(52) U.S. Cl. CPC H01M 10/0431; H01M 50/105; H01M 50/533

(57) ABSTRACT

A rechargeable battery includes an electrode assembly with an exterior shape having a central portion between a first round portion and a second round portion, the electrode assembly including a first electrode with a first substrate and a plurality of first tabs, the plurality of first tabs being positioned continuously without interruption over the first round portion and over a portion of the central portion in contact with the first round portion, and the first electrode including a plurality of first folding lines between the first substrate and the plurality of first tabs, respectively, a second electrode with a second substrate and a plurality of second tabs, and a separator between the first electrode and the second electrode, the first electrode, the separator, and the second electrode being wound around centers of two winding axes, and a case configured to accommodate and seal the electrode assembly.

### CROSS-REFERENCE TO RELATED APPLICATION

This application claims priority to and the benefit of Korean Patent Application No. 10-2023-0107787, filed in the Korean Intellectual Property Office on Aug. 17, 2023, the entire contents of which is incorporated herein by reference.

### BACKGROUND

### 1 Field

The present disclosure relates to a rechargeable battery. More particularly, the present disclosure relates to a structure of an electrode assembly capable of decreasing the resistance of a tab.

### 2. Description of the Related Art

Rechargeable batteries may be used for various purposes, such as a power source for small electronic devices, e.g., mobile phones and laptop computers, and a power source for driving motors for transportation vehicles, e.g., electric vehicles and hybrid vehicles. The rechargeable battery may include an electrode assembly and a case for sealing the electrode assembly, and may be classified into, e.g., a cylindrical battery, a prismatic battery, and a pouch-type battery depending on their appearance.

### SUMMARY

A rechargeable battery includes an electrode assembly and a case configured to accommodate and seal the electrode assembly. The electrode assembly includes a first electrode including a first substrate and a plurality of first tabs, a second electrode including a second substrate and a plurality of second tabs, and a separator located between the first electrode and the second electrode, and forms an exterior form including a central portion and a first round portion and a second round portion as the first electrode, the separator, and the second electrode are wound around centers of two winding axes. The plurality of first tabs are located continuously without interruption over the first round portion and a portion of the central portion in contact with the first round portion. The first electrode includes a plurality of first folding lines located between the first substrate and the plurality of first tabs, respectively.

Each of the plurality of first tabs may include a first portion corresponding to the first round portion and a pair of second portions located on both sides of the first portion and corresponding to the central portion in an unfolded state. A length of the first portion along a length direction of the first substrate may gradually increase away from a winding-start end portion of the first substrate.

A height of the first portion along a width direction of the first substrate may be equal to a height of each of the pair of second portions.

A first concave portion may be located in the first portion. A depth of the first concave portion along a width direction of the first substrate may be greater than or equal to a height of the first portion along the width direction. A length of the first concave portion along to the length direction of the first substrate may be smaller than or equal to the length of the first portion along to the length direction.

The plurality of second tabs may be located continuously without interruption over the second round portion and a portion of the central portion in contact with the second round portion, and the second electrode may include a plurality of second folding lines located between the second substrate and the plurality of second tabs, respectively.

Each of the plurality of second tabs may include a third portion corresponding to the second round portion and a pair of fourth portions located on both sides of the third portion and corresponding to the central portion in an unfolded state. A length of the third portion along a length direction of the second substrate may gradually increase away from a winding-start end portion of the second substrate.

A height of the third portion along a width direction of the second substrate may be equal to a height of each of the pair of fourth portions.

A second concave portion may be located in the third portion. A depth of the second concave portion along a width direction of the second substrate may be greater than or equal to a height of the third portion along the width direction. A length of the second concave portion along the length direction of the second substrate may be smaller than or equal to a length of the third portion along the length direction.

Each of the first folding line and the second folding line may be formed as a mark in which each of the plurality of first tabs and the plurality of second tabs is folded and then unfolded, and located parallel to an edge of the first substrate and edge of the second substrate.

A rechargeable battery includes an electrode assembly and a case configured to accommodate and seal the electrode assembly. The electrode assembly includes a first electrode including a first substrate and a plurality of first tabs, a second electrode including a second substrate and a plurality of second tabs, and a separator located between the first electrode and the second electrode, and forms an exterior form including a central portion and first round portion and a second round portion as the first electrode, the separator, and the second electrode are wound around centers of two winding axes. The plurality of first tabs are located continuously without interruption over the first round portion and a portion of the central portion in contact with the first round portion, and include a first concave portion located in the first round portion.

Each of the plurality of first tabs may include a first portion corresponding to the first round portion and a pair of second portions located on both sides of the first portion and corresponding to the central portion in an unfolded state. A length of the first portion along a length direction of the first substrate may gradually increase away from a winding-start end portion of the first substrate.

The first concave portion may be located in the first portion. A depth of the first concave portion along a width direction of the first substrate may be greater than or equal to a height of the first portion along the width direction. A length of the first concave portion along the length direction of the first substrate may be smaller than or equal to a length of the first portion along the length direction.

The plurality of second tabs may be located continuously without interruption over the second round portion and a portion of the central portion in contact with the second round portion, and include a second concave portion located in the second round portion.

Each of the plurality of second tabs may include a third portion corresponding to the second round portion and a pair of fourth portions located on both sides of the third portion and corresponding to the central portion in an unfolded state. A length of the third portion along a length direction of the second substrate may gradually increase away from a winding-start end portion of the second substrate.

The second concave portion may be located in the third portion. A depth of the second concave portion along a width direction of the second substrate may be greater than or equal to a height of the third portion along the width direction. A length of the second concave portion along a length direction of the second substrate may be smaller than or equal to a length of the fourth portion along the length direction.

### BRIEF DESCRIPTION OF THE DRAWINGS

Features will become apparent to those of skill in the art by describing in detail exemplary embodiments with reference to the attached drawings, in which:

FIG. 1 is a perspective view of an electrode assembly according to an embodiment.

FIG. 2 is an enlarged view of region A in FIG. 1.

FIG. 3 is a top plan view of an unfolded state of a first electrode in the electrode assembly shown in FIG. 1.

FIG. 4 is a cross-sectional view of a first electrode along line A-A of FIG. 3.

FIG. 5 is a top plan view of an unfolded state of a second electrode in the electrode assembly shown in FIG. 1.

FIG. 6 is a cross-sectional view of a second electrode along line B-B of FIG. 5.

FIG. 7 is a top plan view of an unfolded state of a first electrode, a second electrode, and a separator in the electrode assembly shown in FIG. 1.

FIG. 8 is a schematic diagram showing a process of forming a folding line shown in FIG. 3 and FIG. 5.

FIG. 9 is a cross-sectional view of a substrate and a tab along line C-C of FIG. 8.

FIG. 10 is a perspective view of an electrode assembly according to another embodiment.

FIG. 11 is a top plan view of an unfolded state of a first electrode, a separator, and a second electrode in the electrode assembly shown in FIG. 10.

FIG. 12 is a partial enlarged view of FIG. 11.

FIG. 13 is a perspective view of an electrode assembly according to another embodiment.

FIG. 14 is a partial enlarged top plan view of an unfolded state of a first tab and a second tab in the electrode assembly shown in FIG. 13.

FIG. 15 is a perspective view of a rechargeable battery according to another embodiment.

FIG. 16 is a cross-sectional view along line D-D of FIG. 15.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

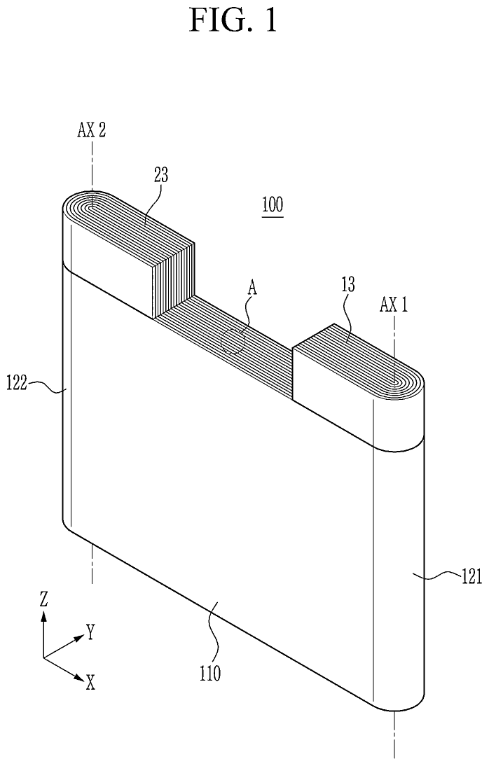

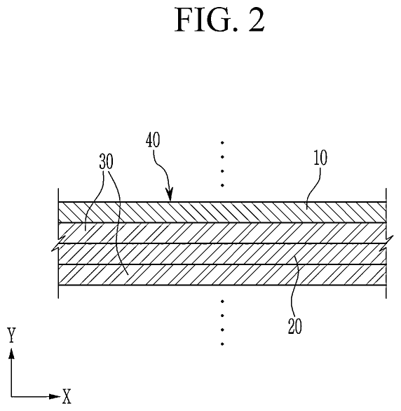

FIG. 1 is a perspective view of an electrode assembly according to an embodiment. FIG. 2 is an enlarged view of region A shown in FIG. 1.

Referring to FIG. 1 and FIG. 2, an electrode assembly 100 may include a first electrode 10, a second electrode 20, and a separator 30. The separator 30 may be located between the first electrode 10 and the second electrode 20 and insulates them from each other. The first electrode 10, the second electrode 20, and the separator 30 may be configured in an elongated strip shape, and may form an exterior form of a flat jelly roll by being wound around centers of two winding axes AX1 and AX2.

For example, the first electrode 10, the separator 30, the second electrode 20, and the separator 30 may be sequentially laminated to form a laminate 40, and the laminate 40 may be wound around centers of a first winding axis AX1 and a second winding axis AX2, located at a distance from each other. That is, the laminate 40 may be wound alternately around the first winding axis AX1 and the second winding axis AX2.

According to winding of the laminate 40, the exterior form of the electrode assembly 100 may include a central portion 110 of a flat quadrangular shape, and a pair of round portions 121 and 122 located on opposites sides (e.g., both sides) of the central portion 110. The central portion 110 may be a flat portion of a preset thickness located between the first winding axis AX1 and the second winding axis AX2. A first round portion 121 may be a curved surface portion of a semicircular shape surrounding the first winding axis AX1, and a second round portion 122 may be a curved surface portion of a semicircular shape surrounding the second winding axis AX2.

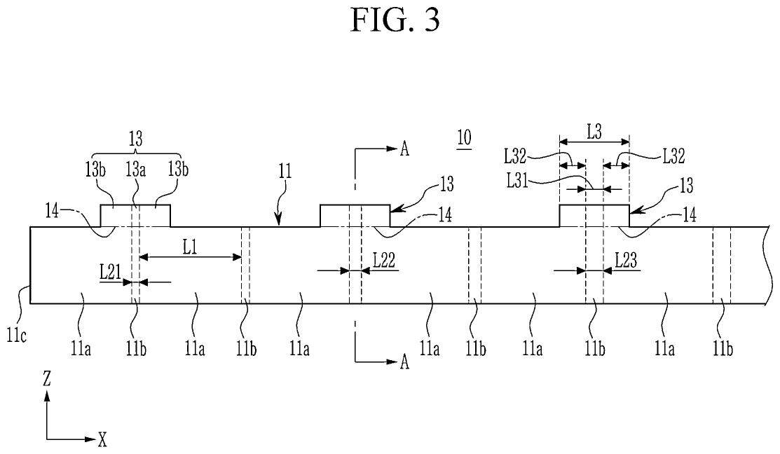

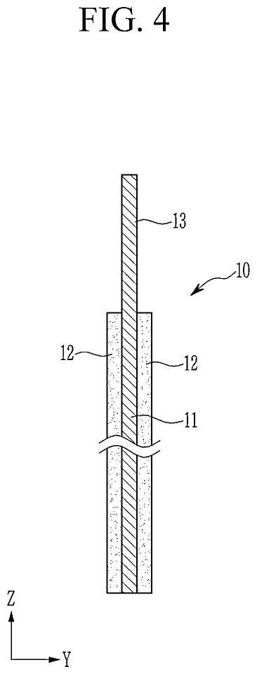

FIG. 3 is a top plan view of an unfolded state of the first electrode 10 in the electrode assembly 100 in FIG. 1. FIG. 4 is a cross-sectional view of the first electrode 10 along line A-A of FIG. 3.

Referring to FIG. 1 to FIG. 4, the first electrode 10 may include a first substrate 11 of an elongated strip shape, first composite material layers 12 located on opposite surfaces (e.g., both surfaces) of the first substrate 11, and a plurality of first tabs 13 expanded (e.g., extending) from the first substrate 11 to a first side (e.g., an upper side). The plurality of first tabs 13 may be located along a length direction (horizontal direction in FIG. 3) of the first substrate 11 with a preset distance to each other. For example, as illustrated in FIGS. 3-4, each of the plurality of first tabs 13 may extend upwardly (e.g., in the Z direction above the first composite material layers 12), and the plurality of first tabs 13 may be spaced apart from each other at preset distances along the X direction.

For example, the first substrate 11 and the plurality of first tabs 13 may be formed as an aluminum foil, and the plurality of first tabs 13 may be formed by a laser punching process. The first composite material layers 12 may be located on entire opposite surfaces (e.g., both surfaces) of the first substrate 11, or may be located on a remaining surface excluding a partial top portion of the first substrate 11. For example, the first composite material layer 12 may include a transition metal oxide, e.g., LiCoO₂, LiNiO₂, LiMn₂O₄, or the like, a conductive material, a binder, or the like.

The first substrate 11 may include a plurality of central parts 11a corresponding to the central portion 110 and a plurality of round parts 11b corresponding to the pair of round portions 121 and 122 in an unfolded state. A central part 11a and a round part 11b may be alternately located one by one along the length direction of the first substrate 11 (e.g., along the X direction in FIG. 3). Odd numbered round parts 11b among the plurality of round parts 11b may correspond to the first round portion 121.

The plurality of central parts 11a may have the same length L1 (e.g., in the X direction), but the plurality of round parts 11b may have gradually increasing lengths (e.g., in the X direction) away from a winding-start end portion 11c of the first substrate 11 (L21<L22<L23 . . . ). For example, referring to FIG. 3, among two adjacent ones of the round parts 11b, a round part 11b closer to the winding-start end portion 11c of the first substrate 11 in the X direction may have a shorter length. Such a difference in lengths of the round parts 11b provides (e.g., accounts or compensates) for increased radius and circumferential length of each of the pair of round portions 121 and 122 as the winding of the laminate 40 progresses.

As illustrated in FIGS. 1 and 3, the plurality of first tabs 13 may be located continuously without interruption over the first round portion 121 and a portion of the central portion 110. Here, a portion of the central portion 110 may be a first side (right side in FIG. 1) region of the central portion 110 in contact with the first round portion 121. A length L3 (e.g., in the X direction) of each of the plurality of first tabs 13 in FIG. 3 may be greater than lengths L21, L22, L23, and so on of the round part 11b with which the first tab 13 is in contact.

For example, as illustrated in FIG. 3, each of the plurality of first tabs 13 may include a first portion 13a in contact with the round part 11b and configuring the first round portion 121 together with the round part 11b, and a pair of second portions 13b in contact with the central part 11a and configuring the central portion 110 together with the central part 11a. The pair of second portions 13b may be located on opposite sides (e.g., both sides) of the first portion 13a along the length direction of the first substrate 11.

A length L31 of the first portion 13a may be the same as a length of the round part 11b in contact with the first portion 13a. That is, the length L31 of the first portion 13a may increase away from the winding-start end portion 11c of the first substrate 11. On the other hand, a length L32 of each of the pair of second portions 13b may be all the same regardless of the distance to the winding-start end portion 11c (e.g., so the length L3, which is a total length of L31 and L32, may gradually increase as the distance from the winding-start end portion 11c increases). A height of the first portion 13a along a width direction (vertical direction or Z direction in FIG. 3) of the first substrate 11 may be equal to a height of each of the pair of second portions 13b.

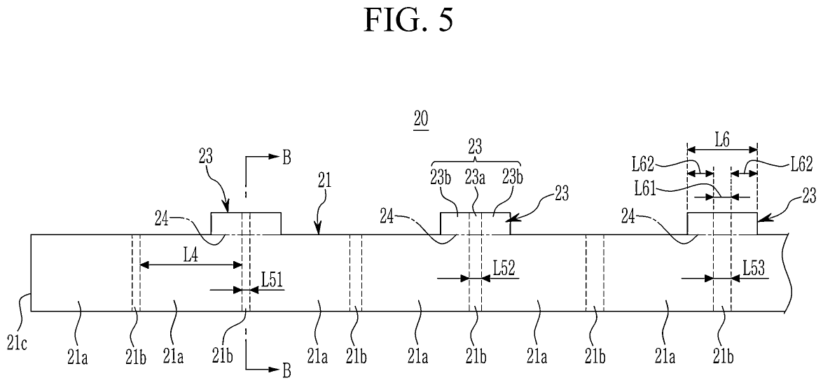

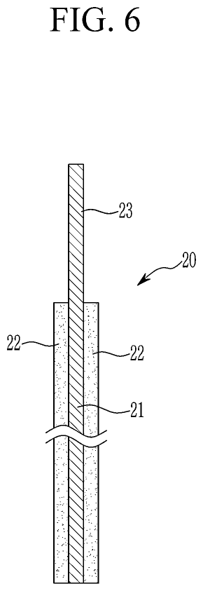

FIG. 5 is a top plan view showing an unfolded state of the second electrode 20 in the electrode assembly 100 shown in FIG. 1. FIG. 6 is a cross-sectional view of the second electrode 20 along line B-B of FIG. 5.

Referring to FIG. 1, FIG. 5, and FIG. 6, the second electrode 20 may include a second substrate 21 of an elongated strip shape, second composite material layers 22 located on opposite surfaces (e.g., both surfaces) of the second substrate 21, and a plurality of second tabs 23 expanded (e.g., extending) from the second substrate 21 to a first side (e.g., the upper side). The plurality of second tabs 23 may be located along the length direction (horizontal direction in FIG. 5) of the second substrate 21 with a preset distance to each other.

For example, the second substrate 21 and the plurality of second tabs 23 may be formed as a copper foil or nickel foil, and the plurality of second tabs 23 may be formed by a laser punching process. The second composite material layers 22 may be located on entire opposite surfaces (e.g., both surfaces) of the second substrate 21, or may be located on a remaining surface excluding a partial top portion of the second substrate 21. The second composite material layers 22 may include, e.g., graphite, a conductive material, a binder, or the like.

The second substrate 21 may include a plurality of central parts 21a corresponding to the central portion 110 and a plurality of round parts 21b corresponding to the pair of round portions 121 and 122 in an unfolded state. The central part 21a and the round part 21b may be alternately located one by one along the length direction of the second substrate 21.

Even numbered round parts among the plurality of round parts 21b may correspond to the second round portion 122. The plurality of central parts 21a may have a same length L4, but the plurality of round parts 21b may have a gradually increasing length away from a winding-start end portion 21c of the second substrate 21 (L51<L52<L53 . . . ).

The plurality of second tabs 23 may be located continuously without interruption over the second round portion 122 and a portion of the central portion 110. Here, a portion of the central portion 110 may be a first side (left side in FIG. 1) region of the central portion 110 in contact with the second round portion 122. A length L6 of each of the plurality of second tabs 23 in in FIG. 5 may be greater than lengths L51, L52, L53, and so on of the round part 21b with which the second tab 23 is in contact.

For example, each of the plurality of second tabs 23 may include a third portion 23a in contact with the round part 21b and configuring the second round portion 122 together with the round part 21b, and a pair of fourth portions 23b in contact with the central part 21a and configuring the central portion 110 together with the central part 21a. The pair of fourth portions 23b may be located on opposite sides (e.g., both sides) of the third portion 23a along the length direction of the second substrate 21.

The length L61 of the third portion 23a may be the same as a length of the round part 21b in contact with the third portion 23a. That is, the length L61 of the third portion 23a may increase away from the winding-start end portion 21c of the second substrate 21. On the other hand, a length L62 of each of the pair of fourth portions 23b may be all the same regardless of the distance to the winding-start end portion 21c. A height of the third portion 23a along the width direction (vertical direction in FIG. 5) of the second substrate 21 may be equal to a height of each of the pair of fourth portions 23b.

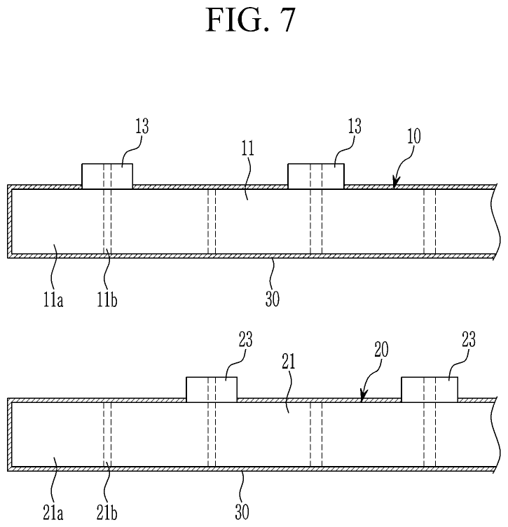

FIG. 7 is a top plan view showing an unfolded state of the first electrode 10, the second electrode 20, and the separator 30 in the electrode assembly shown in FIG. 1.

Referring to FIG. 7, the separator 30 may have a larger area than each of the first substrate 11 and the second substrate 21, and may be located to surround edges of the first substrate 11 and the second substrate 21. For example, as illustrated in FIG. 7, the separator 30 may extend beyond each of the edges of each of the first substrate 11 and the second substrate 21, and an outermost edge of the separator 30 may surround the edges of the first substrate 11 and the second substrate 21 in a top view.

The separator 30 may overlap a portion (lower portion) of the first tab 13 in contact with the first substrate 11 and a portion (lower portion) of the second tab 23 in contact with the second substrate 21. The separator 30 may include a polymer material, e.g., polyethylene or polypropylene, and may insulate the first electrode 10 and the second electrode 20 from each other while allowing movement of lithium ions.

Referring back to FIG. 1, the plurality of first tabs 13 may be provided in a relatively large width over the first round portion 121 and a portion of the central portion 110 (e.g., in the X direction), and the plurality of second tabs 23 may be provided in a relatively large width over the second round portion 122 and a portion of the central portion 110 (e.g., in the X direction). By enlarging widths in the X direction (expressed as ‘length’ in the X direction with respect to FIG. 3 and FIG. 5) of the first tabs 13 and the second tabs 23, the electrical resistance of the first tab 13 and the second tab 23 may decrease, thereby suppressing heating in the region of the first tabs 13 and the second tabs 23 during fast charging and discharging of the rechargeable battery.

Meanwhile, since the plurality of first tabs 13 and second tabs 23 are located in the pair of round portions 121 and 122, a defect may potentially occur during the winding process of the laminate 40 due to an increase of folding strength of the round portions 121 and 122. However, the electrode assembly 100 may include a plurality of folding lines to facilitate bending of the round portions 121 and 122 during the winding process of the laminate 40, as will be described in more detail below with reference to FIGS. 3 and 5, thereby preventing or substantially minimizing the potential defect due to the increase in folding strength.

Referring to FIG. 3 and FIG. 5, the first electrode 10 may include a plurality of first folding lines 14 located between the first substrate 11 and the plurality of first tabs 13, respectively. The plurality of first folding lines 14 may be parallel to a first side (upper side) edge of the first substrate 11. The second electrode 20 may include a plurality of second folding lines 24 located between the second substrate 21 and the plurality of second tabs 23, respectively. The plurality of second folding lines 24 may be parallel to a first side (upper side) edge of the second substrate 21.

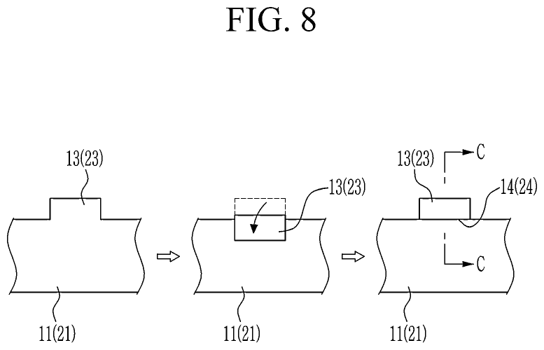

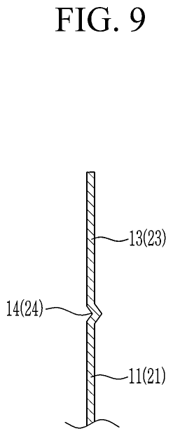

FIG. 8 is a schematic diagram showing a process of forming a folding line shown in FIG. 3 and FIG. 5. FIG. 9 is a cross-sectional view of a substrate and a tab along line C-C of FIG. 8.

Referring to FIG. 8 and FIG. 9, the plurality of first tabs 13 and second tabs 23 may be formed by a laser punching process, and each of the plurality of first tabs 13 and second tabs 23 may be folded by 180° to overlap the first and second substrates 11 and 21 and then unfolded. Then, the first and second folding lines 14 and 24 may be generated between the first and second substrates 11 and 21 and the first and second tabs 13 and 23, respectively.

The first and second folding lines 14 and 24 may be deformed portions occurring on the metal foil configuring the first and second substrates 11 and 21 and the first and second tabs 13 and 23. For example, as illustrated in FIG. 9, the first and second folding lines 14 and 24 may be formed as fine grooves formed on an inner surface and fine protrusions formed on an outer surface between the first and second substrates 11 and 21 and the first and second tabs 13 and 23, respectively. The first and second folding lines 14 and 24 may facilitate bending of the first and second round portions 121 and 122 where the first and second tabs 13 and 23 are located.

Referring to FIG. 1 to FIG. 9, if the laminate 40 is wound around the first winding axis AX1 and the second winding axis AX2, bending in the first and second round portions 121 and 122 may be facilitated by the plurality of first folding lines 14 provided on the first electrode 10 and the plurality of second folding lines 24 provided on the second electrode 20. Accordingly, the electrode assembly 100 may suppress the increase of folding strength of the first and second round portions 121 and 122, thereby preventing the winding defect of the first and second round portions 121 and 122.

For example, the plurality of first tabs 13 may be pressurized (e.g., pressed) in a thickness direction of the electrode assembly 100 (e.g., in the Y direction) to be in tight contact with each other, and may be integrally fixed to each other, e.g., by laser welding. The plurality of second tabs 23 may also be pressurized (e.g., pressed) in the thickness direction of the electrode assembly 100 (e.g., in the Y direction) to be in tight contact with each other, and may be integrally fixed to each other, e.g., by laser welding.

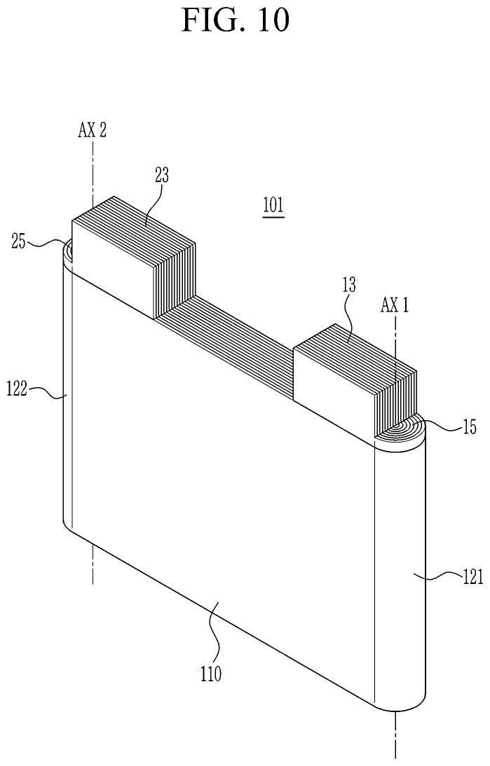

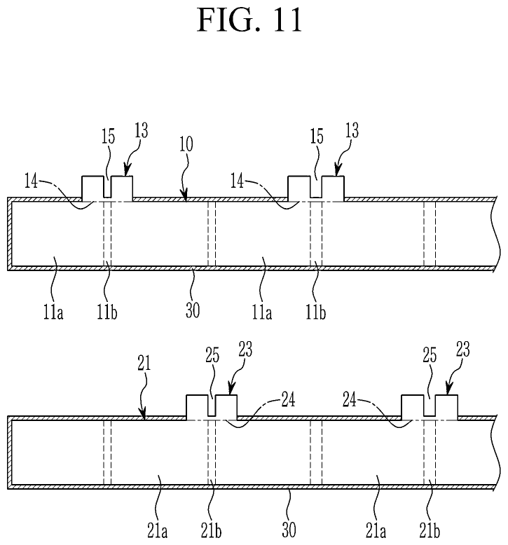

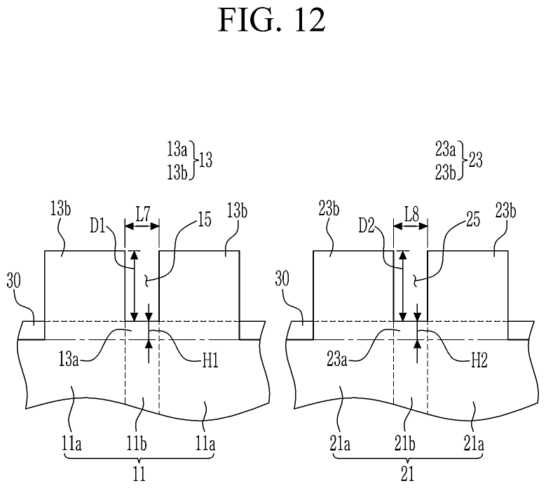

FIG. 10 is a perspective view of an electrode assembly according to another embodiment. FIG. 11 is a top plan view showing an unfolded state of a first electrode, a separator, and a second electrode in the electrode assembly shown in FIG. 10. FIG. 12 is a partial enlarged view of FIG. 11. The electrode assembly of the embodiment in FIGS. 10-12 may be formed in the same or similar configuration as the embodiment described above with reference to FIGS. 1-9, except for the shape of tabs described below.

Referring to FIG. 10 to FIG. 12, each of the plurality of first tabs 13 may include a first concave portion 15 located in the first round portion 121. Each of the plurality of first tabs 13 may include the first portion 13a contacting the round part 11b of the first substrate 11, and the pair of second portions 13b contacting the central part 11a of the first substrate 11 and located on both sides of the first portion 13a. The first concave portion 15 may be located in the first portion 13a.

A length L7 of the first concave portion 15 along the length direction (horizontal direction in FIG. 12) of the first substrate 11 may be equal to the length of the first portion 13a. In addition, a depth D1 of the first concave portion 15 along the width direction (vertical direction in FIG. 12) of the first substrate 11 may be greater than or equal to a height H1 of the first portion 13a. FIG. 10 to FIG. 12 illustrate, as an example, that the depth D1 of the first concave portion 15 is greater than the height H1 of the first portion 13a.

The depth D1 of the first concave portion 15 may be the same as a height of a portion of the first tab 13 protruding toward an outer side of the separator 30. In this case, a first side (upper side) edge of the first portion 13a may coincide (e.g., may be colinear) with a first side (upper side) edge of the separator 30. A plurality of first concave portions 15 may facilitate bending of the first round portion 121 if the laminate 40 is wound around the first winding axis AX1. Optionally, the first folding line 14 may be located between the first substrate 11 and each of the plurality of first tabs 13.

Each of the plurality of second tabs 23 may include a second concave portion 25 located in the second round portion 122. Each of the plurality of second tabs 23 may include the third portion 23a contacting the round part 21b of the second substrate 21, and the pair of fourth portions 23b contacting the central part 21a of the second substrate 21 and located on both sides of the third portion 23a. The second concave portion 25 may be located in the third portion 23a.

A length L8 of the second concave portion 25 along the length direction (horizontal direction in FIG. 12) of the second substrate 21 may be equal to the length of the third portion 23a. In addition, a depth D2 of the second concave portion 25 along the width direction (vertical direction in FIG. 12) of the second substrate 21 may be greater than or equal to a height H2 of the third portion 23a. FIG. 10 to FIG. 12 illustrate, as an example, that the depth D2 of the second concave portion 25 is greater than the height H2 of the third portion 23a.

The depth D2 of the second concave portion 25 may be the same as a height of a portion of the second tab 23 protruding toward the outer side of the separator 30. In this case, a first side (upper side) edge of the third portion 23a may coincide with the first side (upper side) edge of the separator 30. A plurality of second concave portions 25 may facilitate bending of the second round portion 122 if the laminate 40 is wound around the second winding axis AX1. Optionally, a second folding line 24 may be located between the second substrate 21 and each of the plurality of second tabs 23.

In an electrode assembly 101 of the embodiment of FIGS. 10-12, if the laminate 40 is wound around the first winding axis AX1 and the second winding axis AX2, bending in the round portions 121 and 122 may be facilitated by the first concave portion 15 provided on the first electrode 10 and the second concave portion 25 provided on the second electrode 20. Accordingly, the electrode assembly 101 may suppress the increase of folding strength of the first and second round portions 121 and 122, thereby preventing the winding defect of the first and second round portions 121 and 122.

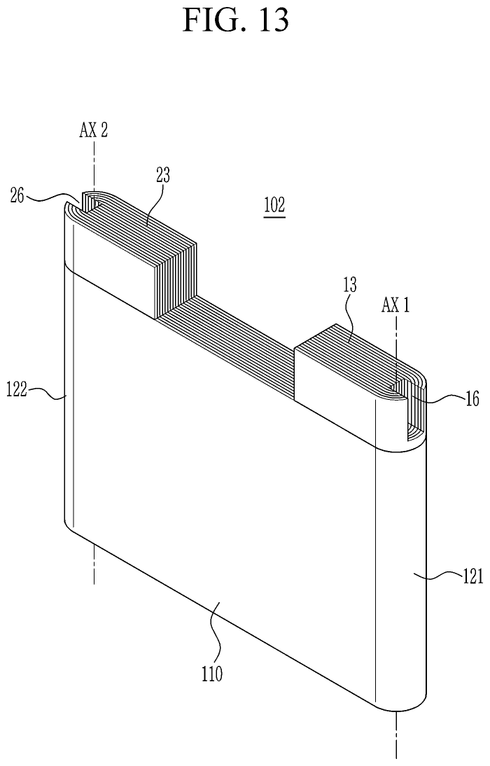

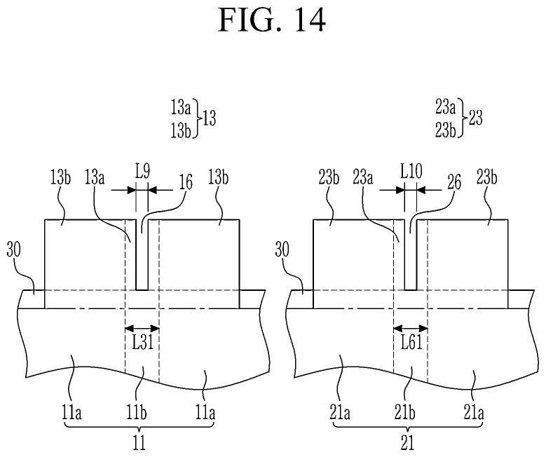

FIG. 13 is a perspective view of an electrode assembly according to another embodiment. FIG. 14 is a partial enlarged top plan view showing an unfolded state of a first tab and a second tab in the electrode assembly shown in FIG. 13. The electrode assembly of the embodiment in FIGS. 13-14 may be formed in the same or similar configuration as the embodiment of FIGS. 10-12, except for the shape of tabs described below.

Referring to FIG. 13 and FIG. 14, each of the plurality of first tabs 13 may include a first concave portion 16 located in a portion of the first round portion 121. Each of the plurality of first tabs 13 may include the first portion 13a contacting the round part 11b of the first substrate 11, and the pair of second portions 13b contacting the central part 11a of the first substrate 11 and located on both sides of the first portion 13a. The first concave portion 16 may be located in a portion of the first portion 13a.

A length L9 of the first concave portion 16 along the length direction (horizontal direction in FIG. 14) of the first substrate 11 may be smaller than the length L31 of the first portion 13a. At this time, a center of the first concave portion 16 may coincide with a center of the first portion 13a. A depth of the first concave portion 16 along the width direction (vertical direction in FIG. 14) of the first substrate 11 may be equal to a depth of the first concave portion 15 described in the embodiment of FIGS. 11-12.

A plurality of first concave portions 16 may facilitate bending of the first round portion 121 if the laminate 40 is wound around the first winding axis AX1. Optionally, the first folding line 14 may be located between the first substrate 11 and each of the plurality of first tabs 13, thereby further facilitating bending of the first round portion 121 together with the first concave portion 16.

Each of the plurality of second tabs 23 may include a second concave portion 26 located in a portion of the second round portion 122. Each of the plurality of second tabs 23 may include the third portion 23a contacting the round part 21b of the second substrate 21, and the pair of fourth portions 23b contacting the central part 21a of the second substrate 21 and located on both sides of the third portion 23a. The second concave portion 26 may be located in a portion of the third portion 23a.

A length L10 of the second concave portion 26 along the length direction (horizontal direction in FIG. 14) of the second substrate 21 may be smaller than the length L61 of the third portion 23a. At this time, a center of the second concave portion 26 may coincide with a center of the third portion 23a. A depth of the second concave portion 26 along the width direction (vertical direction in FIG. 14) of the second substrate 21 may be equal to a depth of the second concave portion 25 described in the embodiment of FIGS. 10-12.

A plurality of second concave portions 26 may facilitate bending of the second round portion 122 if the laminate 40 is wound around the second winding axis AX2. Optionally, the second folding line 24 may be located between the second substrate 21 and each of the plurality of second tabs 23, thereby further facilitating bending of the second round portion 122 together with the second concave portion 26.

In electrode assemblies 101 and 102 of respective FIGS. 10-12 and 13-14 described above, the plurality of first tabs 13 may be pressurized (e.g., pressed) in the thickness direction of the electrode assemblies 101 and 102 to be in tight contact with each other, and may be integrally fixed by, e.g., laser welding. The plurality of second tabs 23 may also be pressurized (e.g., pressed) in the thickness direction of the electrode assemblies 101 and 102 to be in tight contact with each other, and may be integrally fixed by, e.g., laser welding.

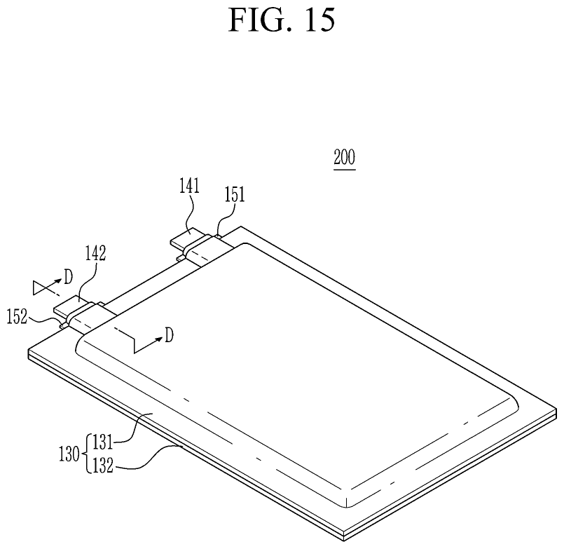

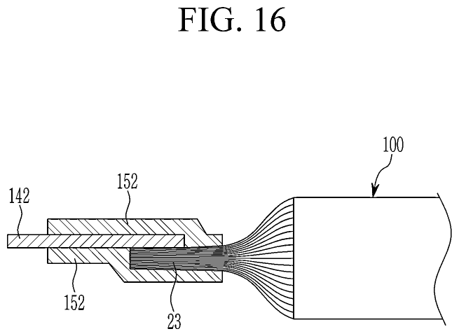

FIG. 15 is a perspective view of a rechargeable battery according to an embodiment. FIG. 16 is a cross-sectional view along line D-D of FIG. 15.

Referring to FIG. 15 and FIG. 16, a rechargeable battery 200 may include the electrode assembly 100, a case 130 surrounding and sealing the electrode assembly 100, and a first lead tab 141 and a second lead tab 142 electrically connected to the electrode assembly 100 and protruding toward an outer side of the case 130. The electrode assembly 100 may be an electrode assembly according to any embodiment among the embodiments described above, and may be accommodated in an interior of the case 130 together with an electrolyte. The case 130 may be configured as either a prismatic type or a pouch type. In FIG. 15, a pouch-type case is shown, as an example. Hereinafter, a case where the case 130 is a pouch-type will be described.

The case 130 may include a first sheet 131 located on a first side of the electrode assembly 100, and a second sheet 132 located on a second side of the electrode assembly 100. Edges of the first sheet 131 and the second sheet 132 may be integrally joined by heat fusion to seal the electrode assembly 100 and the electrolyte. Each of the first sheet 131 and the second sheet 132 may have a multi-layer structure in which at least one metal sheet and a plurality of polymer sheets are combined.

The first lead tab 141 may be fixed to the plurality of first tabs 13 (refer to FIG. 1) by welding or the like, and the second lead tab 142 may be welded to the plurality of second tabs 23 by welding or the like. The first lead tab 141 may be charged with the same polarity as the first electrode 10 (refer to FIG. 2), and the second lead tab 142 may be charged with the same polarity as the second electrode 20 (refer to FIG. 2).

Most of the first lead tab 141 excluding an end portion of the first lead tab 141 and the plurality of first tabs 13 may be surrounded by a first sealing tape 151. Most of the second lead tabs 142 excluding an end portion of the second lead tab 142 and the plurality of second tabs 23 may be surrounded by a second sealing tape 152.

Referring to FIG. 1 and FIG. 15, the electrode assembly 100 may enlarge the areas (e.g., the lengths in the X direction) of the plurality of first tabs 13 and the plurality of second tabs 23 to thereby lower the electrical resistance of the tabs 13 and 23, and may facilitate bending of the first and second round portions 121 and 122 by the folding line 14 or concave portions 15, 16, 25, and 26 described above. The rechargeable battery 200 provided with the electrode assembly 100 may suppress heat generation of portions of the first and second tabs 13 and 23 during fast charging and discharging, and accordingly, operating stability is increased, and safer usage may be enabled.

By way of summation and review, the electrode assembly may be electrically connected to a terminal through an electrode tab, and the terminal allows the current generated by the electrode assembly to flow to an external device. The electrode tab, which collects the current generated from the electrode assembly and transmits it to the terminal, may have a smaller width than the electrode assembly, thereby increasing the electrical resistance. During the process of rapid charging or rapid discharging of the rechargeable battery, heat may be generated at the electrode tab area due to the increased electrical resistance of the electrode tab.

In contrast, the present disclosure provides a rechargeable battery having an electrode assembly capable of suppressing heat generation of a tab portion during rapid charging and discharging by reducing the resistance of the electrode tab. That is, an electrode assembly according to an embodiment may have an enlarged area of the electrode tab to reduce the electrical resistance thereof, and facilitate bending of the round portion by folding lines or concave portions. A rechargeable battery having such an electrode assembly may suppress or substantially minimize heat generation of a tab portion during rapid charging and discharging, thereby increasing operating stability and enabling safer use.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
an electrode assembly with an exterior shape having a central portion between a first round portion and a second round portion, the electrode assembly including:
a first electrode with a first substrate and a plurality of first tabs, the plurality of first tabs being positioned continuously without interruption over the first round portion and over a portion of the central portion in contact with the first round portion, and the first electrode including a plurality of first folding lines between the first substrate and the plurality of first tabs, respectively,
a second electrode with a second substrate and a plurality of second tabs, and
a separator between the first electrode and the second electrode, the first electrode, the separator, and the second electrode being wound around centers of two winding axes; and
a case configured to accommodate and seal the electrode assembly.

2. The rechargeable battery of claim 1, wherein:
each of the plurality of first tabs includes a first portion corresponding to the first round portion and a pair of second portions on opposite sides of the first portion and corresponding to the central portion in an unfolded state; and
a length of the first portion along a length direction of the first substrate gradually increases away from a winding-start end portion of the first substrate.

3. The rechargeable battery of claim 2, wherein a height of the first portion along a width direction of the first substrate is equal to a height of each of the pair of second portions.

4. The rechargeable battery of claim 2, wherein:
a first concave portion is in the first portion,
a depth of the first concave portion along a width direction of the first substrate is greater than or equal to a height of the first portion along the width direction, and
a length of the first concave portion along the length direction of the first substrate is smaller than or equal to the length of the first portion along the length direction.

5. The rechargeable battery of claim 1, wherein:
the plurality of second tabs are located continuously without interruption over the second round portion and over a portion of the central portion in contact with the second round portion; and
the second electrode includes a plurality of second folding lines between the second substrate and the plurality of second tabs, respectively.

6. The rechargeable battery of claim 5, wherein:
each of the plurality of second tabs includes a third portion corresponding to the second round portion and a pair of fourth portions located on opposite sides of the third portion and corresponding to the central portion in an unfolded state; and
a length of the third portion along a length direction of the second substrate gradually increases away from a winding-start end portion of the second substrate.

7. The rechargeable battery of claim 6, wherein a height of the third portion along a width direction of the second substrate is equal to a height of each of the pair of fourth portions.

8. The rechargeable battery of claim 6, wherein:
a second concave portion is in the third portion,
a depth of the second concave portion along a width direction of the second substrate is greater than or equal to a height of the third portion along the width direction, and
a length of the second concave portion along the length direction of the second substrate is smaller than or equal to the length of the third portion along the length direction.

9. The rechargeable battery of claim 5, wherein each of the plurality of first folding lines and the plurality of second folding lines has a shape of a mark in which each of the plurality of first tabs and the plurality of second tabs is folded and then unfolded, and located parallel to an edge of the first substrate and an edge of the second substrate.

10. A rechargeable battery, comprising:
an electrode assembly with an exterior shape having a central portion between a first round portion and a second round portion, the electrode assembly including:
a first electrode with a first substrate and a plurality of first tabs, the plurality of first tabs being positioned continuously without interruption over the first round portion and over a portion of the central portion in contact with the first round portion, and the plurality of first tabs including a first concave portion in the first round portion,
a second electrode with a second substrate and a plurality of second tabs, and
a separator between the first electrode and the second electrode, the first electrode, the separator, and the second electrode being wound around centers of two winding axes; and
a case configured to accommodate and seal the electrode assembly.

11. The rechargeable battery of claim 10, wherein:
each of the plurality of first tabs includes a first portion corresponding to the first round portion and a pair of second portions on opposite sides of the first portion and corresponding to the central portion in an unfolded state; and
a length of the first portion along a length direction of the first substrate gradually increases away from a winding-start end portion of the first substrate.

12. The rechargeable battery of claim 11, wherein:
the first concave portion is in the first portion;
a depth of the first concave portion along a width direction of the first substrate is greater than or equal to a height of the first portion along the width direction; and
a length of the first concave portion along the length direction of the first substrate is smaller than or equal to the length of the first portion along the length direction.

13. The rechargeable battery of claim 10, wherein the plurality of second tabs are positioned continuously without interruption over the second round portion and over a portion of the central portion in contact with the second round portion, and include a second concave portion in the second round portion.

14. The rechargeable battery of claim 13, wherein:
each of the plurality of second tabs includes a third portion corresponding to the second round portion and a pair of fourth portions on opposite sides of the third portion and corresponding to the central portion in an unfolded state; and
a length of the third portion along a length direction of the second substrate gradually increases away from a winding-start end portion of the second substrate.

15. The rechargeable battery of claim 14, wherein:
the second concave portion is in the third portion;
a depth of the second concave portion along a width direction of the second substrate is greater than or equal to a height of the third portion along the width direction; and
a length of the second concave portion along a length direction of the second substrate is smaller than or equal to a length of the fourth portion along the length direction.
